(19) United States
(12) Patent Application Publication
(10) Pub. No.: US 2015/0292682 A1
(43) Pub. Date: Oct. 15, 2015

(54) LIGHTING APPARATUS

(71) Applicant: SAMSUNG ELECTRONICS CO., LTD., Suwon-Si (KR)

(72) Inventors: Jong-Kyung YANG, Hwaseong-si (KR); June JANG, Seoul (KR)

(21) Appl. No.: 14/526,303

(22) Filed: Oct. 28, 2014

(30) Foreign Application Priority Data
Apr. 11, 2014 (KR) 10-2014-0043680

(51) Int. Cl. F21K 99/00; F21V 19/00

(52) U.S. Cl. CPC F21K 9/175; F21V 19/004; F21Y 2103/003

(57) ABSTRACT

Provided is a lighting apparatus including a lighting apparatus body, one or more multilevel fixing pins coupled to the lighting apparatus body, a light-emitting module fixed at the at least one multilevel fixing pin, and a lighting power supply device for supplying power to the light-emitting module.

### CROSS-REFERENCE TO RELATED APPLICATION

This application claims the benefit of Korean Patent Application No. 10-2014-0043680, filed on Apr. 11, 2014, in the Korean Intellectual Property Office, the disclosure of which is incorporated herein in its entirety by reference.

### TECHNICAL FIELD

The inventive concept relates to a lighting apparatus.

### DISCUSSION OF RELATED ART

Due to its high energy efficiency and small size, an LED has recently been highlighted as a light source for a lighting apparatus. Also, LEDs may be used not only in lighting apparatuses but also in flat panel displays, optical communication devices, etc.

To replace an existing plug-in (PL) type lighting with an LED type lighting, a lighting apparatus body has to be changed. In addition, a lighting apparatus body using an LED light source has to be newly designed.

### SUMMARY

The inventive concept provides a lighting apparatus that has a body that may be easily converted from a conventional type to a light-emitting diode (LED) type, and also, since a height of a light-emitting module is randomly adjustable in the lighting apparatus, allows lighting according to various applications to be easily realized.

The inventive concept also provides one or more multilevel fixing pins that may be easily attached to a conventional-type lighting apparatus body and may randomly adjust a height of a light-emitting module to be fixed.

According to an aspect of the inventive concept, there is provided a lighting apparatus including a lighting apparatus body; one or more multilevel fixing pins coupled to the lighting apparatus body; a light-emitting module fixed at the at least one multilevel fixing pin; and a lighting power supply device for supplying power to the light-emitting module.

The one or more multilevel fixing pins may be formed to fix the light-emitting module at one of different levels, and in particular, each of the one or more multilevel fixing pins may have at least two grooves at different levels at which the light-emitting module is to be fixed. Also, a cross-section of each of the at least two grooves may have a circular shape, a wedge shape, a Z-shape, or a quadrangular-shape.

The one or more multilevel fixing pins may be formed of an electroconductive material and may be connected to an electrode of the light-emitting module. Also, the one or more multilevel fixing pins may be electrically connected to the lighting power supply device.

In an embodiment, the lighting apparatus may further include a power connector that is arranged on the light-emitting module and is electrically connectable to the lighting power supply device. Furthermore, the lighting apparatus may further include a jumping connector that is arranged on the light-emitting module and is electrically connectable to another light-emitting module. Also, the one or more multilevel fixing pins may support two facing sides of the light-emitting module.

In an embodiment, the lighting apparatus may further include a lamp socket mounted on the lighting apparatus body, and the light-emitting module may be electrically connected to the lamp socket. In this case, the lighting apparatus may further include a socket adaptor that electrically connects the light-emitting module and the lamp socket, wherein one side of the socket adaptor may be couplable with the light-emitting module, and the other side of the socket adaptor may be couplable with the lamp socket.

The lighting apparatus may further include a diffusion plate for diffusing light that is emitted from the light-emitting module. The one or more multilevel fixing pins may be detachable from the lighting apparatus body. Also, the lighting apparatus may further include a compressible resilient body between the lighting apparatus body and the light-emitting module.

According to another aspect of the inventive concept, there is provided a lighting apparatus including a lighting apparatus body; a light-emitting module disposed on the lighting apparatus body; and a diffusion plate for covering the light-emitting module, wherein a distance between the light-emitting module and the diffusion plate is adjustable.

The lighting apparatus may further include a multilevel fixing pin that is detachable from the lighting apparatus body and supports at least one end of the light-emitting module.

The light-emitting module may receive power via the multilevel fixing pin.

According to another aspect of the inventive concept, there is provided a multilevel fixing pin for fixing a light-emitting module in a lighting apparatus, the multilevel fixing pin including a horizontal fixing part to be coupled with a lighting apparatus body; and a vertical fixing part having at least two grooves to fix a light-emitting module, wherein a cross-section of each of the at least two grooves has a circular shape, a wedge shape, a Z-shape, or a quadrangular-shape.

According to still another aspect of the inventive concept, there is provided a lighting apparatus including a lighting apparatus body; one or more multilevel fixing pins coupled to the lighting apparatus body, each of the multilevel fixing pins including a horizontal fixing part and a vertical fixing part; and a light-emitting module fixed at the one or more multilevel fixing pins. The vertical fixing part may include at least two grooves and the light-emitting module may be inserted into one of the at least two grooves.

### BRIEF DESCRIPTION OF THE DRAWINGS

Exemplary embodiments of the inventive concept will be more clearly understood from the following detailed description taken in conjunction with the accompanying drawings in which:

FIG. 1 is an exploded perspective view of a lighting apparatus, according to an embodiment of the inventive concept;

FIGS. 2 through 6 are cross-sectional views of structures of a substrate included in the lighting apparatus, according to embodiments of the inventive concept;

FIG. 7 is a cross-sectional view of a structure of a metal chassis that may be included in the lighting apparatus, according to an embodiment of the inventive concept;

FIG. 8 illustrates a color temperature spectrum related to light that is emitted from a light-emitting device of the lighting apparatus, according to an embodiment of the inventive concept;

FIG. 9 illustrates an example of a structure of a quantum dot (QD) that may be used in a light-emitting device of the lighting apparatus, according to an embodiment of the inventive concept;

FIG. 10 illustrates phosphor types according to application fields of a white light-emitting device using a blue light-emitting device in the lighting apparatus, according to an embodiment of the inventive concept;

FIGS. 11 through 13 are cross-sectional side views of LED chips that may be used in the lighting apparatus, according to embodiments of the inventive concept;

FIGS. 14 and 15 are cross-sectional side views of LED packages including LED chips that may be used in the lighting apparatus, according to embodiments of the inventive concept;

FIG. 16 is a cross-sectional side view of the lighting apparatus of FIG. 1;

FIGS. 17A through 17C are cross-sectional side views of multilevel fixing pins having various shapes;

FIG. 18 is an exploded perspective view of a lighting apparatus, according to another embodiment of the inventive concept;

FIG. 19 is a perspective view illustrating electrical connection of light-emitting modules that may be used in the lighting apparatus, according to another embodiment of the inventive concept;

FIG. 20 is an exploded perspective view of a lighting apparatus, according to another embodiment of the inventive concept; and

FIGS. 21 and 22 illustrate a home network to which a lighting apparatus according to an embodiment of the inventive concept is applied.

### DETAILED DESCRIPTION OF THE EMBODIMENTS

The inventive concept will now be described more fully with reference to the accompanying drawings, in which exemplary embodiments of the inventive concept are shown. The inventive concept may, however, be embodied in many different forms and should not be construed as being limited to the embodiments set forth herein; rather, these embodiments are provided so that this disclosure will be thorough and complete, and will fully convey the inventive concept to those of ordinary skill in the art. In the drawings, similar reference numerals denote similar configuring elements, and the thicknesses of layers and regions are exaggerated for clarity.

While terms “first” and “second” are used to describe various components, it is obvious that the components are not limited to the terms “first” and “second”. The terms “first” and “second” are used only to distinguish between each component. For example, a first component may indicate a second component or a second component may indicate a first component without conflicting with the inventive concept.

Unless expressly described otherwise, all terms including descriptive or technical terms which are used herein should be construed as having meanings that are obvious to one of ordinary skill in the art. Also, terms that are defined in a general dictionary and that are used in the following description should be construed as having meanings that are equivalent to meanings used in the related description, and unless expressly described otherwise herein, the terms should not be construed as being ideal or excessively formal.

As used herein, the term “and/or” includes any and all combinations of one or more of the associated listed items. Expressions such as “at least one of,” when preceding a list of elements, modify the entire list of elements and do not modify the individual elements of the list.

One or more embodiments of the inventive concept is related to a lighting apparatus that includes a light-emitting module. In more detail, the lighting apparatus includes a lighting apparatus body; one or more multilevel fixing pins that are coupled to the lighting apparatus body; the light-emitting module that is fixed at the one or more multilevel fixing pins; and a lighting power source that is configured to supply power to the light-emitting module.

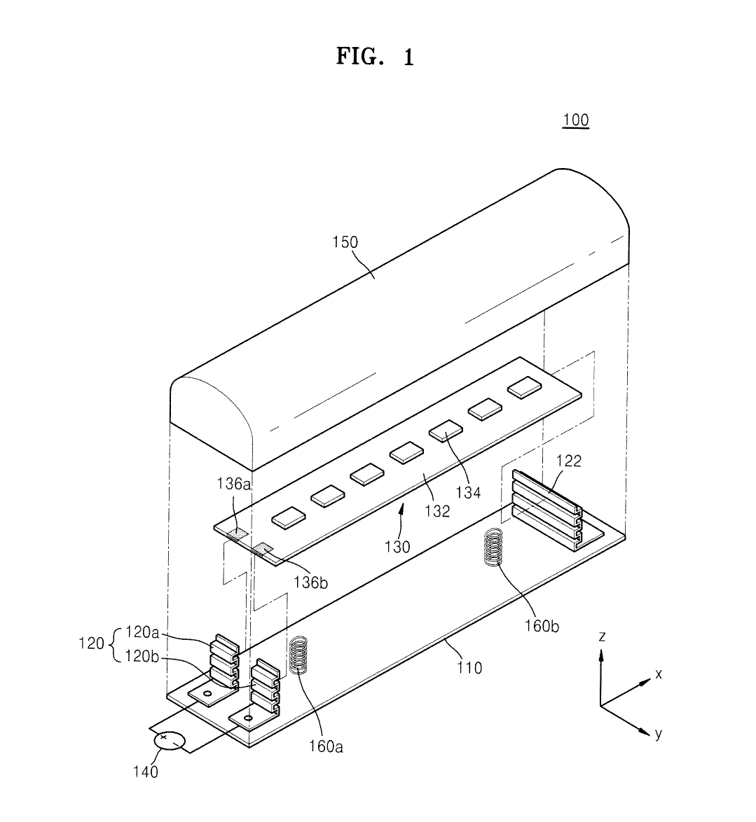

FIG. 1 is an exploded perspective view of a lighting apparatus 100, according to an embodiment of the inventive concept.

Referring to FIG. 1, one or more multilevel fixing pins 120 and 122 may be arranged in a lighting apparatus body 110. The multilevel fixing pins 120 and 122 may be attachable and detachable from the lighting apparatus body 110. For example, the multilevel fixing pins 120 and 122 may be screw-coupled to the lighting apparatus body 110.

Each of the multilevel fixing pins 120 and 122 may include a horizontal fixing part that may be tightly fixed in the lighting apparatus body 110, and a vertical fixing part having at least two grooves formed therein. The multilevel fixing pins 120 and 122 may be formed of a polymer resin, a metal material, or a ceramic material, but a material for the multilevel fixing pins 120 and 122 is not limited thereto.

A light-emitting module 130 may be inserted into and fixed in the grooves in the multilevel fixing pins 120 and 122. The light-emitting module 130 may indicate a combination of a substrate 132 and light-emitting devices 134 that are mounted on the substrate 132. Also, terminals 136a and 136b for receiving power may be arranged at one end of the light-emitting module 130.

For example, the light-emitting module 130 may be a linear module according to the Zhaga standards, and may have a length of 280 mm and a width of 20 nm (i.e., L28W2). Alternatively, the light-emitting module 130 may be characterized by L28W4, L28W6, or L56W4.

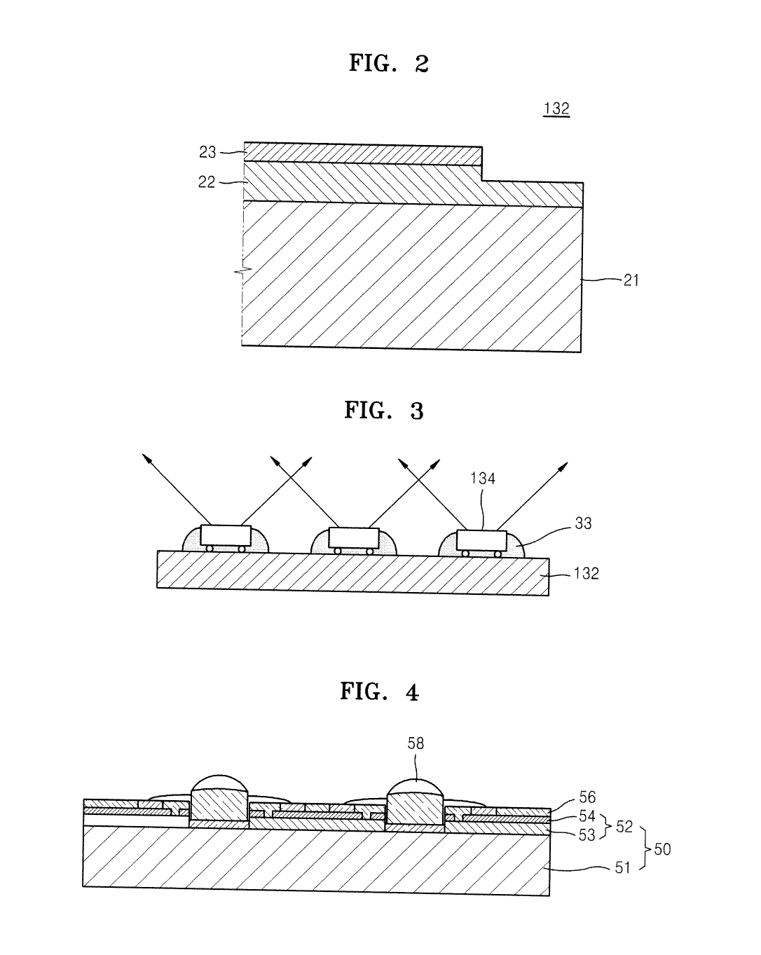

The substrate 132 may be formed as a metal substrate shown in FIG. 2.

As illustrated in FIG. 2, the substrate 132 includes an insulating layer 22 formed on a first metal layer 21, and a second metal layer 23 formed on the insulating layer 22. A stepped region to expose the insulating layer 22 is formed at one side end of the metal substrate.

The first metal layer 21 may be formed of a material having an excellent heat dissipation property such as Al, Fe or alloys thereof, and may have a single-layer structure or a multi-layer structure. The insulating layer 22 may be formed of an insulating material including an inorganic material or an organic material. For example, the insulating layer 22 may be formed of an epoxy-based insulating resin and may further include a metal powder such as an Al powder so as to improve they vial conductivity. In general, the second metal layer 23 may be formed of a Cu thin-film.

In an embodiment, as illustrated in FIG. 3, the substrate 132 may be a circuit board having a structure in which the light-emitting devices 134 are directly mounted on the substrate 132 or a package having the light-emitting devices 134 is mounted on the substrate 132, and then a waterproof agent 33 surrounds the package.

In another embodiment, as illustrated in FIG. 4, a circuit board 50 may have a structure in which a resin coating copper clad laminate (RCC) 52 that is formed of an insulating layer 53 and a copper thin film layer that is stacked on the insulating layer 53 is stacked on a heat dissipation supporting substrate 51, and a protective layer 56 that is formed of a liquid photo solder resist (PSR) is stacked on a circuit layer 54. A portion of the RCC 52 is removed, so that a metal copper clad laminate (MCCL) having at least one groove to which a light-emitting device or package 58 is mounted is formed. In the circuit board 50, an insulating layer at a lower region of the light-emitting device or package 58 at which a light source is positioned is removed, so that the light source contacts the heat dissipation supporting substrate 51, and heat that is generated in the light source is directly transferred to the heat dissipation supporting substrate 51, and thus a heat dissipation performance is enhanced.

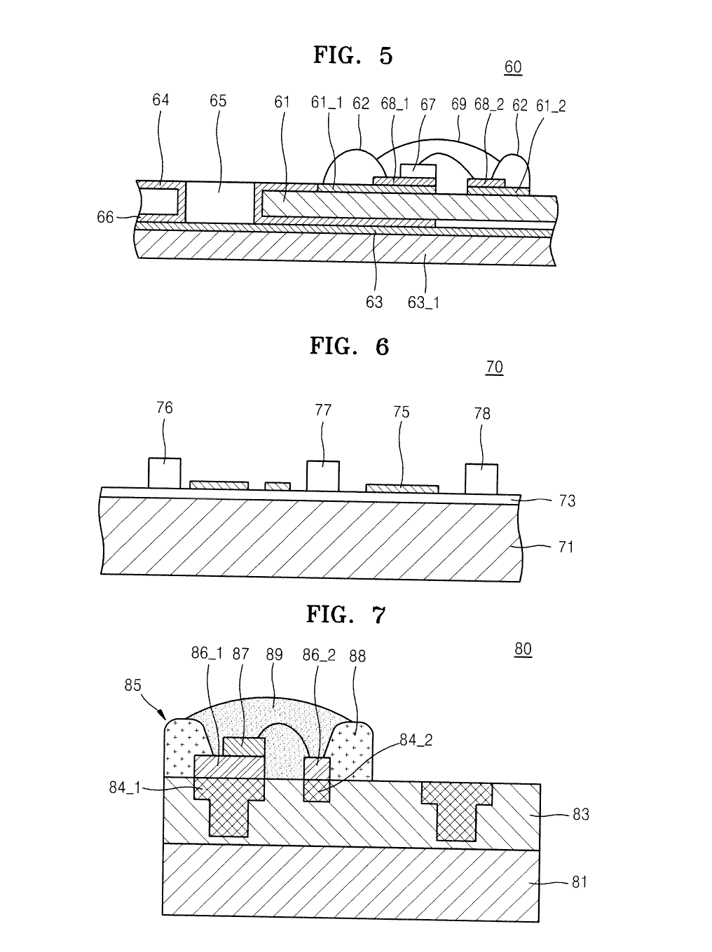

In another embodiment, as illustrated in FIG. 5, a substrate 61 is an insulation substrate and has a structure in which circuit patterns 61_1 and 61_2 formed of a copper laminate are formed on a top surface of the insulation substrate, and an insulation thin film layer 63 that is thinly coated as an insulation material may be formed on a bottom surface of the insulation substrate. Here, various coating methods such as a sputtering method or a spraying method may be used. Also, top and bottom heat diffusion plates 64 and 66 may be formed on the top and bottom surfaces of the substrate 61 so as to dissipate heat that is generated in an LED module 60, and in particular, the top heat diffusion plate 64 may directly contact the circuit pattern 61_1. For example, the insulation material that is used as the insulation thin film layer 63 has thermal conductivity that is significantly lower than that of a heat pad, but since the insulation thin film layer 63 has a very small thickness, the insulation thin film layer 63 may have a thermal resistance that is significantly lower than that of the heat pad. The heat that is generated in the LED module 60 may be transferred to the bottom heat diffusion plate 66 via the top heat diffusion plate 64 and then may be dissipated to a chassis 63_1.

Two through holes 65 may be formed in the substrate 61 and the top and bottom heat diffusion plates 64 and 66 so as to be vertical to the substrate 61. An LED package may include an LED chip 67, LED electrodes 68_1 and 68_2, a plastic molding case 62, a lens 69, etc. The substrate 61 may have a circuit pattern that is formed by laminating a copper layer onto an FR4-core that is a ceramic or epoxy resin-based material and then by performing an etching process.

The LED module 60 may have a structure in which at least one of a red-light LED that emits red light, a green-light LED that emits green light, and a blue-light LED that emits blue light is mounted, and at least one type of a phosphor material may be coated on a top surface of the blue-light LED.

The phosphor material may be sprayed while including a particle powder that is mixed with a resin. The phosphor powder may be plasticized and thus may be formed in the form of a ceramic plate layer on the top surface of the blue-light LED. A size of the phosphor powder may be from about 1 μm to about 50 μm or, for example, from 5 μm to 20 μm. In a case of a nano phosphor, it may be a quantum dot having a size of from about 1 nm to about 500 nm or, for example, from 10 nm to 50 nm.

In another embodiment, as illustrated in FIG. 6, a metal substrate 70 may include a metal plate 71 that is formed of Al or an Al alloy, and an Al anodized layer 73 that is formed on a top surface of the metal plate 71. Heat generation devices 76, 77, and 78 such as LED chips may be mounted on the metal plate 71. The Al anodized layer 73 may insulate a wiring 75 from the metal plate 71.

The metal substrate 70 may be formed of Al or an Al alloy that is relatively less expensive. Alternatively, the metal substrate 70 may be formed of another material such as titanium or magnesium that may be anodized.

The Al anodized (Al₂O₃) layer 73 that is obtained by anodizing Al has a relatively high heat transfer characteristic of about 10 through 30 W/mK. Thus, the metal substrate 70, including the Al anodized layer 73, may have a heat dissipation characteristic that is more excellent than that of a polymer substrate-based PCB or an MCPCB according to the related art.

In another embodiment, as illustrated in FIG. 7, a circuit board 80 includes an insulation resin 83 that is coated on a metal substrate 81, circuit patterns 84_1 and 84_2 that are formed in the insulation resin 83, and an LED chip 87 that is mounted to be electrically connected with the circuit patterns 84_1 and 84_2. Here, the insulation resin 83 having a thickness that is equal to or less than 200 μm may be laminated as a solid-state film on a metal substrate, or may be coated in a liquid state on the metal substrate by using spin coating or a molding method using a blade. A size of an insulation resin layer having an insulation circuit pattern may be equal to or less than a size of the metal substrate. Also, the circuit patterns 84_1 and 84_2 are formed in a manner in which a metal material such as copper is filled in shapes of the circuit patterns 84_1 and 84_2 that are engraved in the insulation resin 83.

Referring to FIG. 7, an LED module 85 includes an LED chip 87, LED electrodes 86_1 and 86_2, a plastic molding case 88, and a lens 89.

In one embodiment, the light-emitting device 134 may be formed of an LED chip. The LED chip may emit blue light, green light, or red light, according to a type of a compound semiconductor consisting of the LED chip. Alternatively, the LED chip may emit ultraviolet (UV) rays. In another embodiment, the light-emitting device 134 may be formed of an UV light diode chip, a laser diode chip, or an organic light-emitting device (OLED) chip. However, according to one or more embodiments of the inventive concept, the light-emitting device 134 may be formed of various light devices other than the aforementioned elements.

The light-emitting devices 134 may be configured so that a Color Rendering Index (CRI) can be adjusted from a sodium lamp level (CRI=40) to a solar level (CRI=100) and also may generate a variety of white light in the color temperature range between from about 2,000K to about 20,000K, and when required, the lighting apparatus 100 may adjust a lighting color according to the ambient atmosphere or mood by generating visible light having a purple, blue, green, red, or orange color, or infrared light. Also, the lighting apparatus 100 may generate light having a special wavelength capable of promoting a growth of plants.

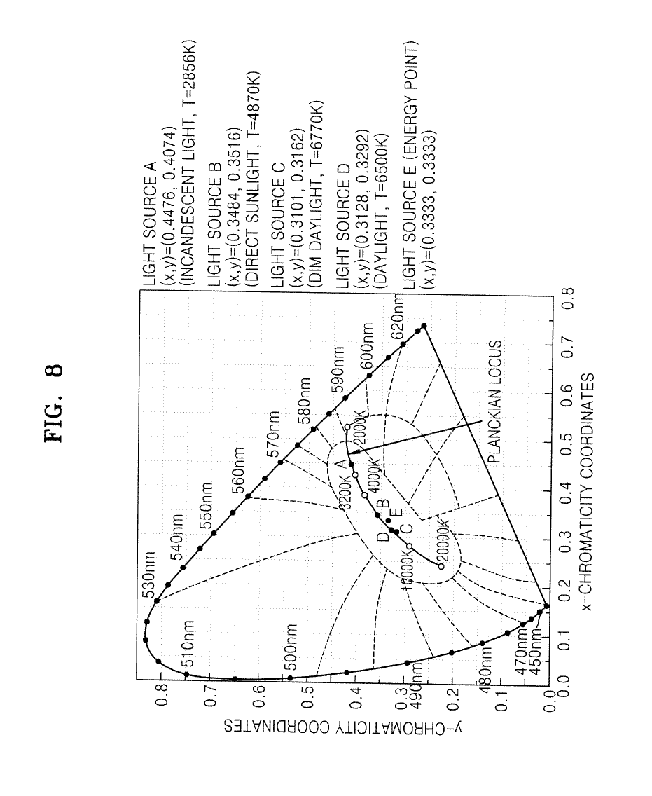

White light that corresponds to a combination of the blue-light LED and the yellow, green, and red phosphors and/or green and red light-emitting devices may have at least two peak wavelengths and may be positioned at a line segment connecting (x, y) coordinates (0.4476, 0.4074), (0.3484, 0.3516), (0.3101, 0.3162), (0.3128, 0.3292), and (0.3333, 0.3333) of a CIE 1931 coordinate system. Alternatively, the white light may be positioned in a region that is surrounded by the line segment and a black body radiation spectrum. A color temperature of the white light may be between about 2,000K through about 20,000K. FIG. 8 illustrates a color temperature (i.e., a Planckian spectrum).

For example, phosphors that are used in an LED may have general formulae and colors as below.

oxide-based phosphors: yellow and green (Y, Lu, Se, La, Gd, Sm)₃(Ga, Al)₅O₁₂:Ce, blue (Y, Lu, Se, La, Gd, Sm)₃(Ga, Al)₅O₁₂:Ce

silicate-based phosphors: yellow and green (Ba, Sr)₂SiO₄:Eu, yellow and orange (Ba, Sr)₃SiO₅:Eu

nitride-based phosphors: green β-SiAlON:Eu, yellow (La, Gd, Lu, Y, Sc)₃Si₆N₁₁:Ce, orange α-SiAlON:Eu, red (Sr, Ca)AlSiN₃:Eu, (Sr, Ca)AlSi(ON)₃:Eu, (Sr, Ca)₂Si₅N₈:Eu, (Sr, Ca)₂Si₅(ON)₈:Eu, (Sr, Ba)SiAl₄N₇:Eu

sulfide-based phosphors: red (Sr, Ca)S:Eu, (Y, Gd)₂O₂S:Eu, green SrGa₂S₄:Eu

fluoride-based phosphors: KSF-based red color K₂SiF₆:Mn⁴⁺

In general, the general formulas of the phosphors must match with the stoichiometry, and each element may be substituted for another element in the same group of the periodic table. For example, Sr may be substituted for Ba, Ca, Mg, or the like of the alkaline-earth metal elements group II, and Y may be substituted for Tb, Lu, Sc, Gd, or the like of lanthanide-base elements. Also, Eu that is an activator may be substituted for Ce, Tb, Pr, Er, Yb, or the like according to a desired energy level, and the activator may be solely used or a sub-activator may be additionally used for a characteristic change.

As a substitute for the phosphors, materials such as a quantum dot or the like may be used, and in this case, the LED, the phosphors, and the quantum dot may be combined or the LED and the quantum dot may be used.

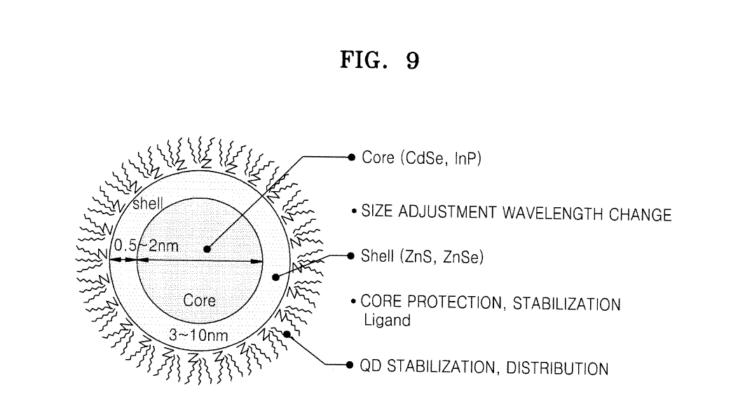

The quantum dot may have a structure of a core (from about 3 nm to about 10 nm) such as CdSe, InP, or the like, a shell (from about 0.5 nm to about 2 nm) such as ZnS, ZnSe, or the like, and a ligand for stabilization of the core-shell, and may realize various colors according to sizes. FIG. 9 illustrates an example of the structure of the quantum dot.

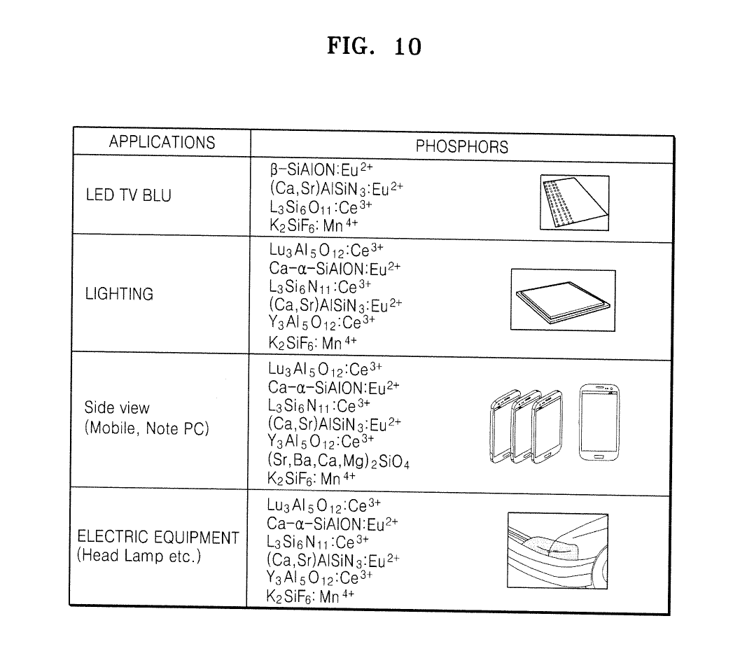

FIG. 10 illustrates phosphor types according to application fields of a white light-emitting device using a blue-light LED.

Phosphors or quantum dots may be sprayed on an LED chip or a light-emitting device, may be coated in the form of a thin-film, or may be attached in the form of a film-sheet or a ceramic phosphor sheet.

The phosphors or the quantum dots may be sprayed by using a dispensing method, a spray coating method, or the like, and in this regard, the dispensing method includes a pneumatic method and a mechanical method such as a screw, a linear type, or the like. A jetting method may allow a dotting amount control via a minute-amount discharge operation, and a color-coordinates control via the dotting amount control. A method of collectively spraying phosphors on a wafer level or a substrate of the light-emitting device may facilitate a control of productivity and a thickness of the light-emitting device.

The method of covering the phosphors or the quantum dots in the form of a thin-film on the light-emitting device or the LED chip may be performed by using an electrophoretic deposition method, a screen printing method, or a phosphor molding method, and one of the aforementioned methods may be used according to whether it is required to cover side surfaces of the LED chip.

To control an efficiency of a long-wavelength light-emitting phosphor that re-absorbs light that is emitted at a short-wavelength and that is from among at least two types of phosphors having different emission wavelengths, the at least two types of phosphors having different emission wavelengths may be distinguished, and to minimize wavelength re-absorption and interference of the LED chip and the at least two types of phosphors, a DBR (ODR) layer may be arranged between layers.

To form a uniform coating layer, the phosphors may be arranged in the form of a film or a ceramic sheet and then may be attached on the LED chip or the light-emitting device.

To vary a light efficiency and a light distribution characteristic, a light conversion material may be positioned in a remote manner, and here, the light conversion material may be positioned together with a light-transmitting polymer material, a glass material, or the like according to durability and heat resistance of the light conversion material.

Since the phosphor spraying technology performs a major role in the determination of a light characteristic of an LED device, various techniques to control a thickness of a phosphor-coated layer, uniform distribution of the phosphors, or the like are being studied. Also, the quantum dot may be positioned at the LED chip or the light-emitting device in the same manner as the phosphors, and in this regard, the quantum dot may be positioned between glass materials or between light-transmitting polymer materials, thereby performing light conversion.

To protect the LED chip or the light-emitting device against an external environment or to improve an extraction efficiency of light that is externally emitted from the light-emitting device, a light-transmitting material as a filling material may be arranged on the LED chip or the light-emitting device.

Here, the light-transmitting material may be a transparent organic solvent including epoxy, silicone, a hybrid of epoxy and silicone, or the like, and may be used after being hardened via heating, light irradiation, a time-elapse, or the like.

With respect to silicone, polydimethyl siloxane is classified into a methyl-base, and polymethylphenyl siloxane is classified into a phenyl-base, and depending on the methyl-base and the phenyl-base, silicone differs in refractive index, water-permeation rate, light transmittance, light stability, and heat-resistance. Also, silicone differs in hardening time according to a cross linking agent and a catalyst, thereby affecting distribution of the phosphors.

The light extraction efficiency varies according to a refractive index of the filling material, and in order to minimize a difference between a refractive index of an outermost medium through which blue light of the LED chip is emitted and a refractive index of the blue light that is emitted to the outside air, at least two types of silicone having different refractive indexes may be sequentially stacked.

In general, the methyl-base has the most excellent heat-resistance, and variation due to a temperature increase is decreased in order of the phenyl-base, the hybrid, and epoxy-base. Silicone may be divided into a gel type, an elastomer type, and a resin type according to a hardness level.

The light-emitting device may further include a lens to radially guide light that is irradiated from a light source, and in this regard, a pre-made lens may be attached on the LED chip or the light-emitting device, or a liquid organic solvent may be injected into a molding frame in which the LED chip or the light-emitting device is mounted and then may be solidified.

The lens may be directly attached on the filling material on the LED chip or may be separated from the filling material by bonding only an outer side of the light-emitting device and an outer side of the lens. The liquid organic solvent may be injected into the molding frame via injection molding, transfer molding, compression molding, or the like.

According to a shape (e.g., a concave shape, a convex shape, a concave-convex shape, a conical shape, a geometrical shape, or the like) of the lens, the light distribution characteristic of the light-emitting device may vary, and the shape of the lens may be changed according to requirements for the light efficiency and the light distribution characteristic.

The light-emitting device 134 may be formed of a semiconductor such as a nitride semiconductor. The nitride semiconductor may be represented by the general formula AlₓGa_{y}In_{z}N (0≦x≦1, 0≦y≦1, 0≦z≦1, x+y+z=1). The light-emitting device 134 may be formed by epitaxially growing the nitride semiconductor such as InN, AlN, InGaN, AlGaN, or InGaAlN on a substrate by using a vapor-phase growing method such as an MOCVD method. Also, the light-emitting device 134 may be fowled of a semiconductor such as ZnO, ZnS, ZnSe, SiC, GaP, GaAlAs, or AlInGaP, other than the nitride semiconductor. The semiconductor may have a stack structure in which an n-type semiconductor layer, an emission layer, and a p-type semiconductor layer are sequentially stacked. The emission layer (i.e., an active layer) may be a stack semiconductor having a multi-quantum well structure, a uni-quantum well structure, or a double-hetero structure. The light-emitting device 134 may emit blue light but is not limited thereto. The light-emitting device 134 may be set to emit light with a random wavelength.

The light-emitting device 134 may be formed as the LED chip having one of various structures or may be formed as an LED package including the LED chips and having one of various forms. Hereinafter, various types of the LED chip and the LED package that may be employed in light source packages according to one of more embodiments of the inventive concept will be described in detail.

<LED Chip—First Embodiment>

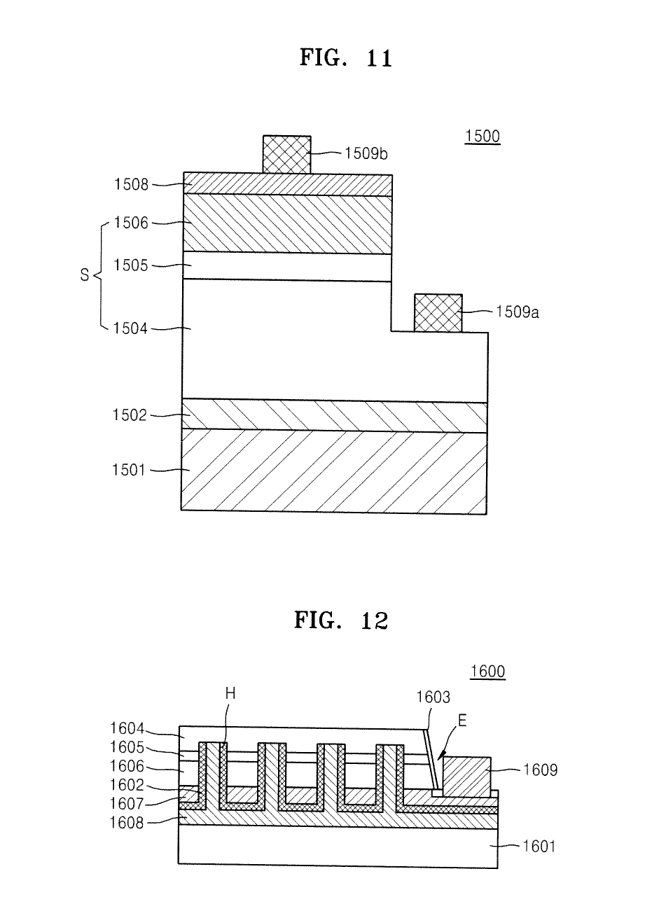

FIG. 11 is a cross-sectional side view of an LED chip 1500 that may be used in a light source package, according to an embodiment of the inventive concept.

As illustrated in FIG. 11, the LED chip 1500 includes an emission stack S that is formed on a substrate 1501. The emission stack S includes a first conductive semiconductor layer 1504, an active layer 1505, and a second conductive semiconductor layer 1506.

Also, the emission stack S includes an ohmic electrode layer 1508 formed on the second conductive semiconductor layer 1506, and a first electrode 1509a and a second electrode 1509b are formed on top surfaces of the first conductive semiconductor layer 1504 and the ohmic contact layer 1508, respectively.

Hereinafter, major elements of the TED chip 1500 are described in detail.

According to necessity, the substrate 1501 may be formed of an insulating substrate, a conductive substrate, or a semiconductor substrate. For example, the substrate 1501 may be formed of sapphire, SiC, Si, MgAl₂O₄, MgO, LiAlO₂, LiGaO₂, or GaN. For an epitaxial growth of a GaN material, it is preferable to use a GaN substrate that is a homogeneous substrate; however, the GaN substrate has a high production cost due to difficulty in its manufacture.

An example of a heterogeneous substrate includes a sapphire substrate, a silicon carbide (SiC) substrate, or the like, and in this regard, the sapphire substrate is used more than the SiC substrate, which is expensive. When the heterogeneous substrate is used, a defect such as dislocation or the like is increased due to a difference between lattice constants of a substrate material and a thin-film material. Also, due to a difference between thermal expansion coefficients of the substrate material and the thin-film material, the substrate 1501 may be bent when a temperature is changed, and the bend causes a crack of a thin-film. The aforementioned problem may be decreased by using a buffer layer 1502 between the substrate 1501 and the emission stack S that includes a GaN material.

To improve an optical or electrical characteristic of the LED chip 1500 before or after an LED structure growth, the substrate 1501 may be completely or partly removed or may be patterned while a chip is manufactured.

For example, the sapphire substrate may be separated in a manner in which a laser is irradiated to an interface between the sapphire substrate and a semiconductor layer, and a silicon substrate or the SiC substrate may be removed by using a polishing method, an etching method, or the like.

When the substrate 1501 is removed, another supporting substrate may be used, and the supporting substrate may be bonded to the other side of an original growth substrate by using a reflective metal material or may be formed by inserting a reflection structure into an adhesion layer, so as to improve an optical efficiency of the LED chip 1500.

A patterning operation on a substrate is performed by forming an uneven or slope surface on a main side (e.g., a top surface or both surfaces) or side surfaces of the substrate before or after a growth of an LED structure, and by doing so, a light extraction efficiency is improved. A size of a pattern may be selected in a range from 5 nm to 500 μm, and in order to improve the light extraction efficiency, a regular pattern or an irregular pattern may be selected. In addition, a shape of the pattern may be a column, a cone, a hemisphere, a polygonal shape, or the like.

The sapphire substrate includes crystals having a hexagonal-rhombohedral (Hexa-Rhombo R3c) symmetry in which lattice constants of the crystal in c-axial and a-lateral directions are 13.001 and 4.758, respectively, and the crystal has a C (0001) surface, an A (1120) surface, an R(1102) surface, or the like. In this case, the C (0001) surface easily facilitates the growth of a nitride thin-film, and is stable at a high temperature, so that the C (0001) surface is commonly used as a substrate for the growth of nitride.

The substrate is formed as a Si substrate that is more appropriate for a large diameter and has a relatively low price, so that mass production may be improved. However, since the Si substrate having a (111) surface as a substrate surface has a lattice constant difference of about 17% with GaN, a technology is required to suppress occurrence of a defective crystal due to the lattice constant difference. In addition, a thermal expansion difference between silicon and GaN is about 56%, so that a technology is required to suppress wafer bend caused due to the thermal expansion difference. Due to the wafer bend, a GaN thin-film may have a crack, and it may be difficult to perform a process control such that dispersion of emission wavelength in a same wafer may be increased.

Since the Si substrate absorbs light that is generated in a GaN-based semiconductor, an external quantum efficiency of the light-emitting device 10 may deteriorate, so that, the Si substrate is removed when required, and a supporting substrate such as Si, Ge, SiAl, ceramic, or metal substrates including a reflective layer may be additionally formed and then may be used.

When the GaN thin-film is grown on a heterogeneous substrate such as the Si substrate, a dislocation density may be increased due to a mismatch between lattice constants of a substrate material and a thin-film material, and the crack and the bend may occur due to the thermal expansion difference. In order to prevent the dislocation and the crack of the emission stack S, the buffer layer 1502 is disposed between the substrate 1501 and the emission stack S. The buffer layer 1502 decreases the dispersion of the emission wavelength of the wafer by adjusting a bending level of the substrate while the active layer is grown.

The buffer layer 1502 may be formed of AlₓIn_{y}Ga(_{1-x-y})N (0≦x≦1, 0≦y≦1, 0≦x+y≦1), in particular, GaN, AlN, AlGaN, InGaN, or InGaNAlN, and when required, the buffer layer 1502 may be formed of ZrB2, HfB2, ZrN, HfN, TiN, or the like. Also, the buffer layer 1502 may be formed by combining a plurality of layers or by gradually varying composition of one of the aforementioned materials.

Since the Si substrate and the GaN thin-film has the large thermal expansion difference, when the GaN thin-film is grown on the Si substrate, the GaN thin-film is grown at a high temperature and then is cooled at a room temperature, and at this time, a tensile stress may be applied to the GaN thin-film due to the thermal expansion difference between the Si substrate and the GaN thin-film, such that a crack in the GaN thin-film may easily occur. In order to prevent the crack, a compressive stress may be applied to the GaN thin-film while the GaN thin-film is grown, so that the tensile stress may be compensated.

Due to the lattice constant difference between the Si substrate and the GaN thin-film, the Si substrate may be defective. When the Si substrate is used, a buffer layer having a composite structure is used so as to simultaneously perform a defect control and a stress control to suppress the bend.

For example, AlN is first formed on the substrate 1501. In order to prevent reaction between Si and Ga, it is required to use a material that does not contain Ga. Not only AlN but also SiC may be used. AlN is grown by using Al and N sources at a temperature between 400 through 1300 degrees. When required, an AlGaN intermediate layer may be inserted into a plurality of AlN layers so as to control a stress.

The emission stack S having a multi-layer structure of the group-III nitride semiconductor is now described in detail. The first and second conductive semiconductor layers 1504 and 1506 may be formed of semiconductors that are doped with n-type and p-type impurities, respectively, or vice versa. For example, each of the first and second conductive semiconductor layers 1504 and 1506 may be formed of, but is not limited to, the group-III nitride semiconductor, e.g., a material having a composition of AlₓIn_{y}Ga_{(1-x-y)}N (0≦x=1, 0≦y≦1, 0≦x+y≦1). In another embodiment, each of the first and second conductive semiconductor layers 1504 and 1506 may be formed of a material including an AlGaInP-based semiconductor, an AlGaAs-based semiconductor, or the like.

Each of the first and second conductive semiconductor layers 1504 and 1506 may have a single-layer structure. However, when required, each of the first and second conductive semiconductor layers 1504 and 1506 may have a multi-layer structure including a plurality of layers having different compositions or thicknesses. For example, each of the first and second conductive semiconductor layers 1504 and 1506 may have a carrier injection layer capable of improving an efficiency of electron and hole injection, and may also have a superlattice structure having various forms.

The first conductive semiconductor layer 1504 may further include a current diffusion layer (not shown) that is adjacent to the active layer 1505. The current diffusion layer may have a structure in which a plurality of InₓAl_{y}Ga_{1-x-y)}N layers having different compositions or different impurity ratios are repeatedly stacked, or may be partially formed of an insulation material layer.

The second conductive semiconductor layer 1506 may further include an electron block layer that is adjacent to the active layer 1505. The electron block layer may have a structure in which a plurality of InₓAl_{y}Ga_{(1-x-y)}N layers having different compositions are stacked or may have at least one layer formed of Al_{y}Ga_{(1-y)}N. Since the electron block layer has a bandgap larger than that of the active layer 1505, the electron block layer prevents electrons from entering to the second conductive semiconductor layer 1506 (that is a p-type).

The emission stack S may be formed by using an MOCVD apparatus. In more detail, the emission stack S is formed in a manner in which a reaction gas such as an organic metal compound gas (e.g., trimethyl gallium (TMG), trimethyl aluminum (TMA), or the like) and a nitrogen containing gas (e.g. ammonia (NH3) or the like) are injected into a reaction container in which the substrate 1501 is arranged and the substrate 1501 is maintained at a high temperature of about 900 through 1100 degrees, while a gallium-based compound semiconductor is grown on the substrate 1501, if required, an impurity gas is injected, so that the gallium-based compound semiconductor is stacked as an undoped-type, an n-type, or a p-type. Si is an n-type impurity. Zn, Cd, Be, Mg, Ca, Ba, or the like, in particular, Mg and Zn, may be used as p-type impurity.

The active layer 1505 that is disposed between the first and second conductive semiconductor layers 1504 and 1506 may have a multi-quantum well (MQW) structure in which a quantum well layer and a quantum barrier layer are alternately stacked. For example, in a case of a nitride semiconductor, the active layer 1505 may have a GaN/InGaN structure. However, in another embodiment, the active layer 1505 may have a single-quantum well (SQW) structure.

The ohmic electrode layer 1508 may decrease an ohmic contact resistance by relatively increasing an impurity density, so that the ohmic electrode layer 1508 may decrease an operating voltage and may improve a device characteristic. The ohmic electrode layer 1508 may be formed of GaN, InGaN, ZnO, or a graphene layer.

The first electrode 1509a or the second electrode 1509b may include a material such as Ag, Ni, Al, Rh, Pd, Ir, Ru, Mg, Zn, Pt, Au, or the like, or may have a multi-layer structure including Ni/Ag, Zn/Ag, Ni/Al, Zn/Al, Pd/Ag, Pd/Al, Ir/Ag. Ir/Au, Pt/Ag, Pt/Al, Ni/Ag/Pt, or the like.

While the LED chip 1500 shown in FIG. 11 has a structure in which the first electrode 1509a, the second electrode 1509b, and a light extraction surface face the same side, the LED chip 1500 may have various structures such as a flip-chip structure in which the first electrode 1509a and the second electrode 1509b face the opposite side of the light extraction surface, a vertical structure in which the first electrode 1509a and the second electrode 1509b are formed on opposite surfaces, a vertical and horizontal structure employing an electrode structure in which a plurality of vias are formed in a chip so as to increase an efficiency of current distribution and heat dissipation.

<LED Chip—Second Embodiment>

FIG. 12 illustrates an LED chip 1600 having a structure useful for increasing an efficiency of current distribution and heat dissipation, when a large area light-emitting device chip for a high output for a lighting apparatus is manufactured, according to another embodiment of the inventive concept.

As illustrated in FIG. 12, the LED chip 1600 includes a first conductive semiconductor layer 1604, an active layer 1605, a second conductive semiconductor layer 1606, a second electrode layer 1607, an insulating layer 1602, a first electrode layer 1608, and a substrate 1601. Here, in order to be electrically connected to the first conductive semiconductor layer 1604, the first electrode layer 1608 includes one or more contact holes H that are electrically insulated from the second conductive semiconductor layer 1606 and the active layer 1605 and that extend from a surface of the first electrode layer 1608 to a portion of the first conductive semiconductor layer 1604. In the present embodiment, the first electrode layer 1608 is not an essential element.

The contact hole H extends from an interface of the first electrode layer 1608 to an inner surface of the first conductive semiconductor layer 1604 via the second conductive semiconductor layer 1606 and the active layer 1605. The contact hole H extends to an interface between the active layer 1605 and the first conductive semiconductor layer 1604, and more preferably, the contact hole H extends to the portion of the first conductive semiconductor layer 1604. Since the contact hole H functions to perform electrical connection and current distribution of the first conductive semiconductor layer 1604, the contact hole H achieves its purpose when the contact hole H contacts the first conductive semiconductor layer 1604, thus, it is not required for the contact hole to extend to an outer surface of the first conductive semiconductor layer 1604.

The second electrode layer 1607 that is formed on the second conductive semiconductor layer 1606 may be formed of a material selected from the group consisting of Ag, Ni, Al, Rh, Pd, Ir, Ru, Mg, Zn, Pt, and Au, in consideration of a light reflection function and an ohmic contact with the second conductive semiconductor layer 1606, and may be formed via a sputtering process or a deposition process.

The contact hole H has a shape that penetrates through the second electrode layer 1607, the second conductive semiconductor layer 1606, and the active layer 1605 so as to be connected with the first conductive semiconductor layer 1604. The contact hole H may be formed via an etching process using ICP-RIE or the like.

The insulating layer 1602 is formed to cover side walls of the contact hole H and a top surface of the second conductive semiconductor layer 1606. In this case, a portion of the first conductive semiconductor layer 1604 that corresponds to a bottom surface of the contact hole H may be exposed. The insulating layer 1602 may be formed by depositing an insulation material such as SiO₂, SiOₓN_{y}, or the like. The insulating layer 1602 may be deposited with a thickness range from about 0.01 μm to about 3 μm at a temperature of 500° C. or less via a CVD process.

The second electrode layer 1607 that includes a conductive via formed by filling a conductive material is formed in the contact hole H. A plurality of the vias may be formed in a light-emitting device region. The number of vias and a contact area of the vias may be adjusted so that an area of the vias that contact a first conductive-type semiconductor is within a range between about 1% and about 5% of an area of the light-emitting device region. A planar radius of the area of the vias that contact the first conductive-type semiconductor is within a range between about 5 μm and about 50 μm, and the number of vias may be between 1 and 50 for each light-emitting device region, according to an area of each light-emitting device region. Although the number of vias may vary according to the area of each light-emitting device region, the number of vias may be at least 3. A distance between the vias may correspond to a matrix array of rows and columns in the range between about 100 μm and about 500 μm, and in more detail, in the range between about 150 μm and about 450 μm. When the distance between the vias is less than about 100 μm, the number of vias is increased so that an emission area is relatively decreased such that an emission efficiency deteriorates. When the distance is greater than about 500 μm, a current spread may be difficult such that an emission efficiency may deteriorate. A depth of the contact hole H may vary according to a second semiconductor layer and an active layer and may be in the range between about 0.5 μm and about 5.0 μm.

Afterward, the substrate 1601 is formed on a surface of the first electrode layer 1608. In this structure, the substrate 1601 may be electrically connected to the first conductive semiconductor layer 604 via the conductive via that contacts the first conductive semiconductor layer 1604.

The substrate 1601 may be formed of a material selected from the group consisting of Au, Ni, Al, Cu, W, Si, Se, GaAs, SiAl, Ge, SiC, AlN, Al₂O₃, GaN, and AlGaN, via a plating process, a sputtering process, a deposition process, or an adhesion process. However, a material and a forming method with respect to the substrate 1601 are not limited thereto.

In order to decrease a contact resistance of the contact hole H, a total number of contact holes H, a shape of the contact hole H, a pitch of the contact hole H, a contact area of the contact hole H with respect to the first and second conductive semiconductor layers 1604 and 1606, or the like may be appropriately adjusted, and since the contact holes H are arrayed in various forms along rows and columns, a current flow may be improved.

≧LED Chip—Third Embodiment>

Since an LED lighting apparatus provides an improved heat dissipation characteristic, it is preferable to apply an LED chip having a small calorific value to the LED lighting apparatus, in consideration of a total heat dissipation performance. An example of the LED chip may be an LED chip having a nano structure (hereinafter, referred to as a “nano LED chip”).

An example of the nano LED chip includes a core-shell type nano LED chip. The core-shell type nano LED chip generates a relatively small amount of heat due to its small combined density, and increases its emission area by using the nano structure so as to increase emission efficiency. Also, the core-shell type nano LED chip may obtain a non-polar active layer, thereby preventing efficiency deterioration due to polarization, so that a drop characteristic may be improved.

FIG. 13 illustrates a nano LED chip 1700 that may be applied to the lighting apparatus 100, according to another embodiment of the inventive concept.

As illustrated in FIG. 13, the nano LED chip 1700 includes a plurality of nano emission structures (not shown) that are formed on a substrate 1701. In the present embodiment, the nano emission structure N has a rod structure as a core-shell structure, but in another embodiment, the nano emission structure N may have a different structure such as a pyramid structure.

The nano LED chip 1700 includes a base layer 1702 formed on the substrate 1701. The base layer 1702 may be a layer to provide a growth surface for the nano emission structures N and may be formed of a first conductive semiconductor. A mask layer 1703 having open areas for a growth of the nano emission structures N (in particular, a core) may be formed on the base layer 1702. The mask layer 1703 may be formed of a dielectric material such as SiO₂ or SiNx.

In the nano emission structure N, a first conductive nano core 1704 is formed by selectively growing the first conductive semiconductor by using the mask layer 1703 having open areas, and an active layer 1705 and a second conductive semiconductor layer 1706 are formed as a shell layer on a surface of the first conductive nano core 1704. By doing so, the nano emission structure N may have a core-shell structure in which the first conductive semiconductor is a nano core, and the active layer 1705 and the second conductive semiconductor layer 1706 that surround the nano core are the shell layer.

In the present embodiment, the nano LED chip 1700 includes a filling material 1707 that fills gaps between the nano emission structures N. The filling material 1707 may structurally stabilize the nano emission structures N. The filling material 1707 may include, but is not limited to, a transparent material such as SiO₂. An ohmic contact layer 1708 may be formed on the nano emission structure N so as to contact the second conductive semiconductor layer 1706. The nano LED chip 1700 includes first and second electrodes 1709a and 1709b that contact the base layer 1702, which is formed of the first conductive semiconductor, and the ohmic contact layer 1708, respectively.

By varying a diameter, a component, or a doping density of the nano emission structure N, light having at least two different wavelengths may be emitted from one device. By appropriately adjusting the light having the different wavelengths, white light may be realized in the one device without using a phosphor. In addition, by combining the one device with another LED chip or combining the one device with a wavelength conversion material such as a phosphor, light having desired various colors or white light having different color temperatures may be realized.

<LED Chip—Fourth Embodiment>

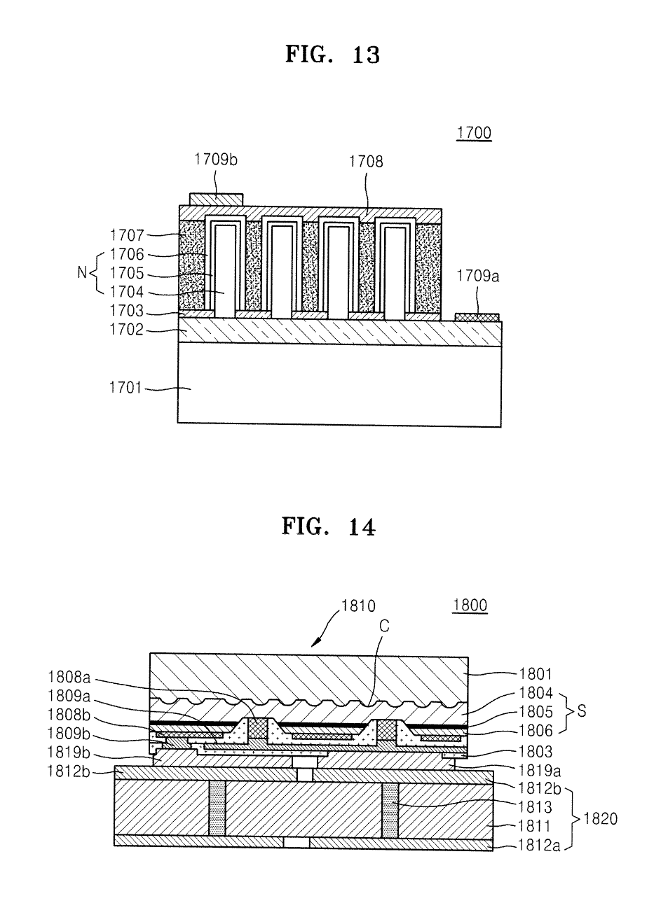

FIG. 14 illustrates a semiconductor light-emitting device 1800 that is a light source to be applied to a light source package and that includes an LED chip 1810 mounted on a mounting substrate 1820, according to an embodiment of the inventive concept.

The semiconductor light-emitting device 1800 shown in FIG. 14 includes the mounting substrate 1820 and the LED chip 1810 that is mounted on the mounting substrate 1820. The LED chip 1810 is different from the LED chips in the aforementioned embodiments.

The LED chip 1810 includes an emission stack S that is disposed on a surface of the substrate 1801, and first and second electrodes 1808a and 1808b that are disposed on the other surface of the substrate 1801 with respect to the emission stack S. Also, the LED chip 1810 includes an insulation unit 1803 to cover the first and second electrodes 1808a and 1808b.

The first and second electrodes 1808a and 1808b may include first and second electrode pads 1819a and 1819b via first and second electric power connection units 1809a and 1809b.

The emission stack S may include a first conductive semiconductor layer 1804, an active layer 1805, and a second conductive semiconductor layer 1806 that are sequentially disposed on the substrate 1801. The first electrode 1808a may be provided as a conductive via that contacts the first conductive semiconductor layer 1804 by penetrating through the second conductive semiconductor layer 1806 and the active layer 1805. The second electrode 1808b may contact the second conductive semiconductor layer 1806.

A plurality of the vias may be formed in a light-emitting device region. The number of vias and a contact area of the vias may be adjusted so that an area of the vias that contact a first conductive-type semiconductor is within a range between about 1% and about 5% of an area of the light-emitting device region. A planar radius of the area of the vias that contact the first conductive-type semiconductor is within a range between about 5 μm and about 50 μm, and the number of vias may be between 1 and 50 vias for each light-emitting device region, according to an area of each light-emitting device region. Although the number of vias may vary according to the area of each light-emitting device region, the number of vias may be at least 3. A distance between the vias may correspond to a matrix array of rows and columns in the range between about 100 μm and about 500 μm, and in more detail, in the range between about 150 μm and about 450 μm. When the distance between the vias is less than about 100 μm, the number of vias is increased so that an emission area is relatively decreased such that an emission efficiency deteriorates. However, when the distance is greater than about 500 μm, a current spread may be difficult such that an emission efficiency may deteriorate. A depth of the contact hole H may vary according to a second semiconductor layer and an active layer and may be in the range between about 0.5 μm and about 5.0 μm.

A conductive ohmic material is deposited on the emission stack S so that the first and second electrodes 1808a and 1808b are formed. The first and second electrodes 1808a and 1808b may be electrodes each including at least one material selected from the group consisting of Ag, Al, Ni, Cr, Cu, Au, Pd, Pt, Sn, Ti, W, Rh, Ir, Ru, Mg, Zn, and an alloy thereof. For example, the second electrode 1808b may be formed as an ohmic electrode including an Ag layer deposited with respect to the second conductive semiconductor layer 1806. The Ag-ohmic electrode functions to reflect light. Selectively, a single layer including Ni, Ti, Pt, or W or a layer of an alloy thereof may be alternately stacked on the Ag layer. In more detail, a Ni/Ti layer, a TiW/Pt layer, or a Ti/W layer may be stacked below the Ag layer or the aforementioned layers may be alternately stacked below the Ag layer.

The first electrode 1808a may be formed in a manner that a Cr layer may be stacked with respect to the first conductive semiconductor layer 1804 and then Au/Pt/Ti layers may be sequentially stacked on the Cr layer, or an Al layer may be stacked with respect to the second conductive semiconductor layer 1806 and then Ti/Ni/Au layers may be sequentially stacked on the Al layer.

To improve an ohmic characteristic or a reflective characteristic, the first and second electrodes 1808a and 1808b may be formed of various materials or may have various stacking structures, other than the aforementioned materials and structures.

The insulation unit 1803 may have an open area to expose a portion of the first and second electrodes 1808a and 1808b, and the first and second electrode pads 1819a and 1819b may contact the first and second electrodes 1808a and 1808b. The insulation unit 1803 may be deposited to have a thickness between about 0.01 μm and about 3 μm via SiO₂ and/or SiN CVD processes at a temperature about 500° C. or less.

The first and second electrodes 1808a and 1808b may be disposed in the same direction, and as will be described later, the first and second electrodes 1808a and 1808b may be mounted in the form of a flip-chip in a lead frame. In this case, the first and second electrodes 1808a and 1808b may be disposed to face in the same direction.

In particular, the first electric power connection unit 1809a may be formed by the first electrode 1808a having a conductive via that penetrates through the active layer 1805 and the second conductive semiconductor layer 1806 and then is connected to the first conductive semiconductor layer 1804 in the emission stack S.

In order to decrease a contact resistance between the conductive via and the first electric power connection unit 1809a, a total number, shapes, pitches, a contact area with the first conductive semiconductor layer 1804, or the like of the conductive via and the first electric power connection unit 1809a may be appropriately adjusted, and since the conductive via and the first electric power connection unit 1809a are arrayed in rows and columns, a current flow may be improved.

An electrode structure of the other side of the semiconductor light-emitting device 1800 may include the second electrode 1808b that is directly formed on the second conductive semiconductor layer 1806, and the second electric power connection unit 1809b that is formed on the second electrode 1808b. The second electrode 1808b may function to form an electrical ohmic connection with the second electric power connection unit 1809b and may be formed of a light reflection material, so that, when the LED chip 1810 is mounted as a flip-chip structure, the second electrode 1808b may efficiently discharge light, which is emitted from the active layer 1805, toward the substrate 1801. Obviously, according to a major light emission direction, the second electrode 1808b may be formed of a light-transmitting conductive material such as transparent conductive oxide.

The aforementioned two electrode structures may be electrically separated from each other by using the insulation unit 1803. Any material or any object having an electrical insulation property may be used as the insulation unit 1803, but it is preferable to use a material having a low light-absorption property. For example, silicon oxide or silicon nitride such as SiO₂, SiOₓN_{y}, SiₓN_{y}, or the like may be used. When required, the insulation unit 1803 may have a light reflection structure in which a light reflective filler is distributed throughout a light transmitting material.

The first and second electrode pads 1819a and 1819b may be connected to the first and second electric power connection units 1809a and 1809b, respectively, and thus may function as external terminals of the LED chip 1810. For example, the first and second electrode pads 1819a and 1819b may be formed of Au, Ag, Al, Ti, W, Cu, Sn, Ni, Pt, Cr, NiSn, TiW, AuSn, or a eutectic alloy thereof. In this case, when the first and second electrode pads 1819a and 1819b are mounted on the mounting substrate 1820, the first and second electrode pads 1819a and 1819b may be bonded to the mounting substrate 1820 by using eutectic metal, so that a separate solder bump that is generally used in flip-chip bonding may not be used. Compared to a case of using the solder bump, the mounting method using the eutectic metal may achieve a more excellent heat dissipation effect. In this case, in order to obtain the excellent heat dissipation effect, the first and second electrode pads 1819a and 1819b may be formed while having large areas.

The substrate 1801 and the emission stack S may be understood by referring to the aforementioned descriptions, unless contrary description is provided. Also, although not particularly illustrated, a buffer layer may be formed between the emission stack S and the substrate 1801, and in this regard, the buffer layer may be formed as a undoped semiconductor layer including nitride or the like, so that the buffer layer may decrease a lattice defect of an emission structure that is grown on the buffer layer.

The substrate 1801 may have first and second primary surfaces that face each other, and in this regard, a convex-concave structure may be formed on at least one of the first and second primary surfaces. The convex-concave structure that is arranged on one surface of the substrate 1801 may be formed of the same material as the substrate 1801 since a portion of the substrate 1801 is etched, or may be formed of a different material from the substrate 1801.

As in the present embodiment, since the convex-concave structure is formed at an interface between the substrate 1801 and the first conductive semiconductor layer 1804, a path of light emitted from the active layer 1805 may vary, such that a rate of light that is absorbed in the semiconductor layer may be decreased and a light-scattering rate may be increased; thus, the light extraction efficiency may be increased.

In more detail, the convex-concave structure may have a regular shape or an irregular shape. Heterogeneous materials that form the convex-concave structure may include a transparent conductor, a transparent insulator, or a material having excellent reflectivity. In this regard, the transparent insulator may include, but is not limited to, SiO₂, SiNx, Al₂O₃, HfO, TiO₂, or ZrO, the transparent conductor may include, but is not limited to, TCO such as indium oxide containing ZnO or an additive including Mg, Ag, Zn, Sc, Hf, Zr, Te, Se, Ta, W, Nb, Cu, Si, Ni, Co, Mo, Cr, or Sn, and the reflective material may include, but is not limited to, Ag, Al, or DBR that is formed of a plurality of layers having different refractive indexes.

The substrate 1801 may be removed from the first conductive semiconductor layer 1804. In order to remove the substrate 1801, a laser lift off (LLO) process using a laser, an etching process, or a grinding process may be performed. After the substrate 1801 is removed, the convex-concave structure may be formed on a top surface of the first conductive semiconductor layer 1804.

As illustrated in FIG. 14, the LED chip 1810 is mounted on the mounting substrate 1820. The mounting substrate 1820 has a structure in which upper and lower electrode layers 1812b and 1812a are formed on a top surface and a bottom surface of a substrate body 1811, respectively, and a via 1813 penetrates through the substrate body 1811 so as to connect the upper and lower electrode layers 1812b and 1812a. The substrate body 1811 may be formed of resin, ceramic, or metal, and the upper and lower electrode layers 1812b and 1812a may be metal layers including Au, Cu, Ag, Al, or the like.

Obviously, an example of a substrate on which the LED chip 1810 is mounted is not limited to the mounting substrate 1820 of FIG. 14, and thus any substrate having a wiring structure to drive the LED chip 1810 may be used. For example, it is possible to provide a package structure in which the LED chip 1810 is mounted in a package body having a pair of lead frames.

<LED Chip—Additional Embodiment>

An LED chip having one of various structures may be used, other than the aforementioned LED chips. For example, it is possible to use an LED chip having a light extraction efficiency that is significantly improved by interacting a quantum well exciton and surface-plasmon polaritons (SPP) formed at an interface between metal and dielectric layers of the LED chip.

<LED Package>

The aforementioned various LED chips may be mounted as bare chips on a circuit board and then may be used in a lighting apparatus. However, unlike this, the LED chips may be also alternatively used in various package structures that are mounted in a package body having a pair of electrodes.

A package including the LED chip (hereinafter, referred to as an LED package) may have not only an external terminal structure that is easily connected to an external circuit but also may have a heat dissipation structure for improvement of a heat dissipation characteristic of the LED chip and various optical structures for improvement of a light characteristic of the LED chip. For example, the various optical structures may include a wavelength conversion unit that converts light emitted from the LED chip into light having a different wavelength, or may include a lens structure for improvement of a light distribution characteristic of the LED chip.

<Example of the LED Package—Chip Scale Package (CSP)>

The example of the LED package that may be used in the lighting apparatus may include an LED chip package having a CSP structure.

The CSP may reduce a size of the LED chip package, may simplify the manufacturing process, and may be appropriate for mass production. In addition, an LED chip, wavelength conversion materials such as phosphors, and an optical structure such as a lens may be integrally manufactured, so that the CSP may be designed as appropriate for the lighting apparatus.

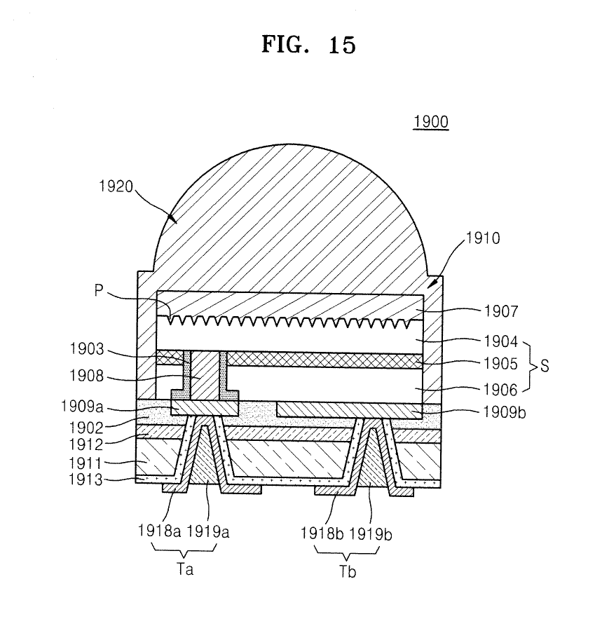

FIG. 15 illustrates an example of a CSP 1900 that has a package structure in which an electrode is formed via a bottom surface of an LED 1910 that is in an opposite direction of a primary light extraction surface, and a phosphor layer 1907 and a lens 1920 are integrally formed, according to an embodiment of the inventive concept.

The CSP 1900 shown in FIG. 15 includes an emission stack S disposed on a mounting substrate 1911, first and second terminals Ta and Tb, the phosphor layer 1907, and the lens 1920.

The emission stack S has a stack structure including first and second conductive semiconductor layers 1904 and 1906, and an active layer 1905 disposed between the first and second conductive semiconductor layers 1904 and 1906. In the present embodiment, the first and second conductive semiconductor layers 1904 and 1906 may be p-type and n-type semiconductor layers, respectively, and may be formed of a nitride semiconductor such as AlₓIn_{y}Ga_{1-x-y})N (0≦x≦1, 0≦y≦1, 0≦x+y≦1). Alternatively, the first and second conductive semiconductor layers 1904 and 1906 may be formed of a GaAs-based semiconductor or a GaP-based semiconductor, other than the nitride semiconductor.

The active layer 1905 that is disposed between the first and second conductive semiconductor layers 1904 and 1906 may emit light that has a predetermined energy due to recombination of electrons and holes and may have a MQW structure in which a quantum well layer and a quantum barrier layer are alternately stacked. The MQW structure may include an InGaN/GaN structure or an AlGaN/GaN structure.

The first and second conductive semiconductor layers 1904 and 1906, and the active layer 1905 may be formed via a semiconductor layer growing process such as MOCVD, MBE, HVPE, or the like that is well known in the art.

In the LED 1910 shown in FIG. 15, a growth substrate is already removed, and a concave-convex structure P may be formed on a surface of the LED 1910 from which the growth substrate is removed. Also, the phosphor layer 1907 is formed as a light conversion layer on the surface whereon the concave-convex structure is formed.

The LED 1910 may have first and second electrodes 1909a and 1909b that contact the first and second conductive semiconductor layers 1904 and 1906, respectively. The first electrode 1909a has a conductive via 1908 that contacts the first conductive semiconductor layer 1904 by penetrating through the second conductive semiconductor layer 1906 and the active layer 1905. The conductive via 1908 has an insulating layer 1903 formed between the active layer 1905 and the second conductive semiconductor layer 1906, thereby preventing a short.

Although one conductive via 1908 is arranged, in another embodiment, at least two conductive vias 1908 may be arranged for improved current distribution and may be arrayed in various forms.

The mounting substrate 1911 is a supporting substrate such as a silicon substrate to be easily applied to a semiconductor procedure, but examples of the mounting substrate 1911 may vary. The mounting substrate 1911 and the LED 1910 may be bonded to each other via bonding layers 1902 and 1912. The bonding layers 1902 and 1912 may be formed of an electrically insulating material or an electrically conductive material, and in this regard, examples of the electrically insulating material may include oxide such as SiO₂, SiN, or the like, or resin materials including a silicon resin, an epoxy resin, or the like, and examples of the electrically conductive material may include Ag, Al, Ti, W, Cu, Sn, Ni, Pt, Cr, NiSn, TiW, AuSn, or a eutectic metal thereof. The bonding process may be performed in a manner in which the bonding layers 1902 and 1912 are arranged on bonding surfaces of the LED 1910 and the mounting substrate 1911 and then are bonded together.

A via that penetrates through the mounting substrate 1911 is formed at a bottom surface of the mounting substrate 1911 so as to contact the first and second electrodes 1909a and 1909b of the bonded LED 1910. Then, an insulator 1913 may be formed on a side surface of the via and the bottom surface of the mounting substrate 1911. When the mounting substrate 1911 is formed as a silicon substrate, the insulator 1913 may be arranged as a silicon oxide layer that is formed via a thermal oxidation process. By filling the via with a conductive material, the first and second terminals Ta and Tb are formed to be connected to the first and second electrodes 1909a and 1909b. The first and second terminals Ta and Tb may include seed layers 1918a and 1918b, and plating charging units 1919a and 1919b that are formed by using the seed layers 1918a and 1918b via a plating process.

Referring back to FIG. 1, the multilevel fixing pins 120 and 122 may be deformed by a force applied thereto in a positive X-axis direction or a negative X-axis direction. When application of the force is stopped, the multilevel fixing pins 120 and 122 may return to their original positions. Thus, when the multilevel fixing pin 120 is deformed by a force that is applied in a negative X-axis direction to the multilevel fixing pin 120, the light-emitting module 130 is inserted into the grooves, and then, when application of the force is stopped, the multilevel fixing pin 120 may return to its original position, thus, the light-emitting module 130 may be coupled in the grooves.

Similarly, when the multilevel fixing pin 122 is deformed by a force that is applied in a positive X-axis direction to the multilevel fixing pin 122, the light-emitting module 130 is inserted into the groove, and then, when application of the force is stopped, the multilevel fixing pin 122 may return to its original position, thus, the light-emitting module 130 may be coupled in the groove. As a result, the light-emitting module 130 may be inserted into the grooves of the multilevel fixing pins 120 and 122.

Compressible resilient bodies 160a and 160b may be further arranged between the light-emitting module 130 and the lighting apparatus body 110. The compressible resilient bodies 160a and 160b may be, but are not limited to, arbitrary resilient bodies that may be deformed while restoring force against a compressive force in a Z-axis direction. For example, each of the compressible resilient bodies 160a and 160b may be, but is not limited to, a spring.

When the light-emitting module 130 is inserted into the grooves of the multilevel fixing pins 120 and 122, the compressible resilient bodies 160a and 160b are deformed by a force applied thereto in a Z-axis direction and restoring force. At a later time, when the light-emitting module 130 is detached from the multilevel fixing pins 120 and 122, a force may be applied in a negative X-axis direction to the multilevel fixing pin 120 and/or may be applied in a positive X-axis direction to the multilevel fixing pin 122. By doing so, the restoring force of the compressible resilient bodies 160a and 160b may push up the light-emitting module 130 in a positive Z-axis direction, so that the light-emitting module 130 may be easily detached.

Also, the multilevel fixing pins 120 and 122, and the light-emitting module 130 may be covered by a diffusion plate 150. The diffusion plate 150 may be transparent or translucent, and may function to uniformly diffuse light that is emitted from the light-emitting module 130, and to protect the multilevel fixing pins 120 and 122 and the light-emitting module 130 disposed therein.

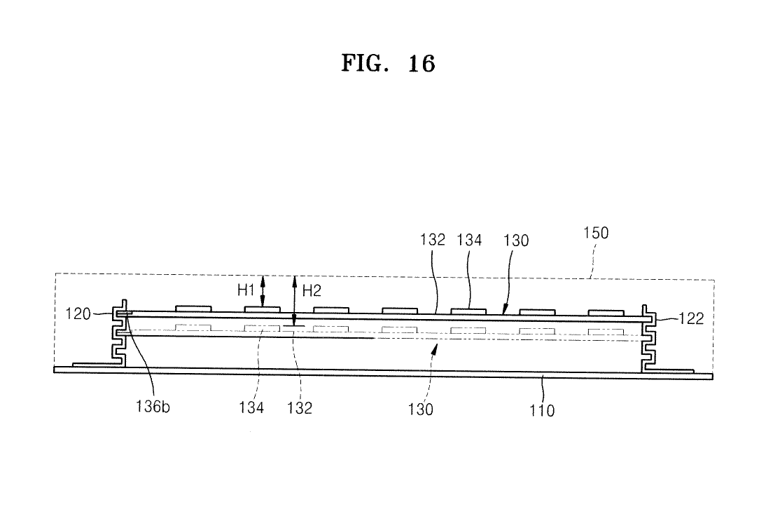

As illustrated in FIG. 1, since at least two grooves having different levels are formed in the multilevel fixing pins 120 and 122, it is possible to select a level of a groove among the grooves in which the light-emitting module 130 is inserted. By selecting the level of the groove to which the light-emitting module 130 is inserted, a distance between the light-emitting module 130 and the diffusion plate 150 may be adjustable. This will be described in detail with reference to FIG. 16.

Also, the multilevel fixing pin 120 may function as a terminal for supplying power to the light-emitting module 130. To do so, electrodes 136a and 136b may be arranged at an end of the light-emitting module 130 that is coupled with the multilevel fixing pin 120. The electrodes 136a and 136b may be formed of a conductive material such as metal. Referring to FIG. 1, the electrodes 136a and 136b are arranged at a top surface of the light-emitting module 130 but are not limited thereto. The electrodes 136a and 136b may be arranged at the top surface, a side edge and/or a bottom surface of the light-emitting module 130.

Also, the multilevel fixing pin 120 may be formed of a conductive material such as metal and may be electrically connected to a lighting power supply device 140. One 120a of the multilevel fixing pin 120 may be connected to a first electrode of the lighting power supply device 140, and the other one 120b of the multilevel fixing pin 120 may be connected to a second electrode of the lighting power supply device 140.

The lighting power supply device 140 may have its own power source or may receive power from an external source and then may supply power to the multilevel fixing pin 120. The power from the external source may be direct current power or alternating current power, and the power that is supplied from the lighting power supply device 140 to the multilevel fixing pin 120 may be set to be direct current power.

As illustrated in FIG. 1, the multilevel fixing pin 120 that supplies power to the light-emitting module 130 is disposed at one side of the light-emitting module 130, the multilevel fixing pin 122 that is disposed at the other side may function only to fix the light-emitting module 130 and may not function to supply power. Thus, the multilevel fixing pin 122 may not be an electrical conductor.

FIG. 16 is a cross-sectional side view of the lighting apparatus 100 of FIG. 1.

Referring to FIG. 16, the light-emitting module 130, which is indicated with a solid line, may be coupled and fixed at a first level of the multilevel fixing pins 120 and 122. As described above, the light-emitting module 130 may be fixed at a different level. In this regard, the light-emitting module 130 indicated with a dotted line may be coupled and fixed at a second level of the multilevel fixing pins 120 and 122.

When the light-emitting module 130 is coupled and fixed at the first level, a distance between the light-emitting devices 134 and the diffusion plate 150 may be H1. When the light-emitting module 130 is coupled and fixed at the second level, a distance between the light-emitting devices 134 and the diffusion plate 150 may be H2. As illustrated in FIG. 16, since H2 is greater than H1, light that is emitted from the light-emitting devices 134 at the second level is further diffused so that lighting may be more uniform. Also, at the second level, positions of the light-emitting devices 134 are distant from the diffusion plate 150 reached by the light, thus, intensity of the light may be lessened.

Therefore, as described above, since a height of the light-emitting module 130 in the lighting apparatus 100 is adjustable, it is possible to select lighting that creates a uniform and soft mood or lighting that creates a bright and clear mood.

Referring to FIG. 16, a cross-sectional side of each of the multilevel fixing pins 120 and 122 is quadrangular but one or more embodiments are not limited thereto.

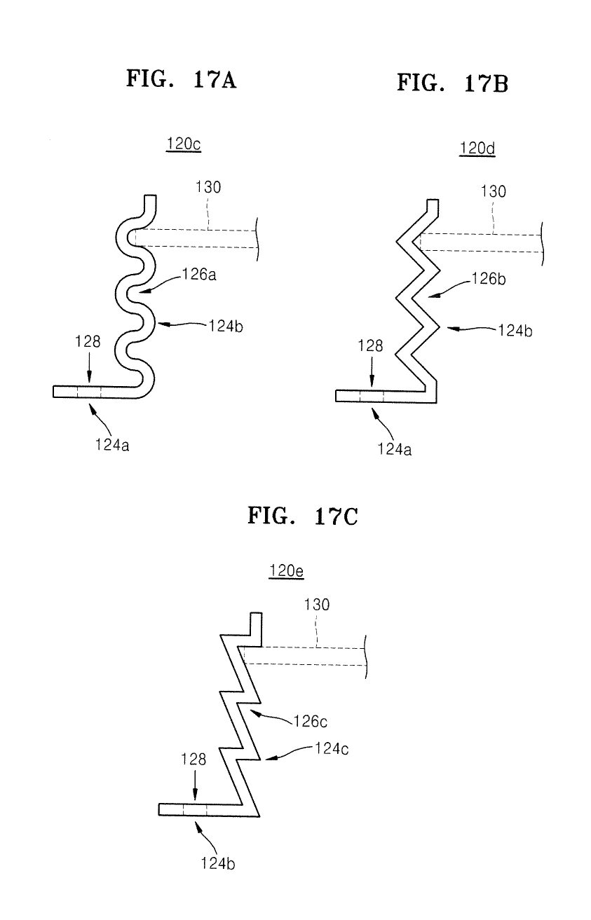

FIGS. 17A through 17C are cross-sectional side views of multilevel fixing pins 120c, 120d, and 120e having various shapes.

Referring to FIG. 17A, a cross-section of a groove 126a has a circular shape, referring to FIG. 17B, a cross-section of a groove 126b has a wedge shape, and referring to FIG. 17C, a cross-section of a groove 126c has a Z-shape. However, one or more embodiments are not limited thereto.

As illustrated in FIGS. 17A through 17C, each of the multilevel fixing pins 120c, 120d, and 120e may have a horizontal fixing part 124a that may be coupled with the lighting apparatus body 110 (refer to FIG. 16), and a vertical fixing part 124b formed at the grooves 126a, 126b, and 126c. For example, a coupling opening 128 for detachable coupling with the lighting apparatus body 110 may be arranged at the horizontal fixing part 124a.

Referring to FIG. 17A, since the cross-section of the groove 126a has the circular shape, both insertion and detachment of the light-emitting module 130 may be relatively easy. Referring to FIG. 17B, since the cross-section of the groove 126b has the wedge shape, both insertion and detachment of the light-emitting module 130 may be relatively easy.

Referring to FIG. 17C, since the cross-section of the groove 126b has the Z-shape, when the light-emitting module 130 is inserted, a force in an X-axis direction may not be required to be applied to the multilevel fixing pin 120c, and with only a force in a vertical direction (i.e., a negative Z-axis direction) applied to the light-emitting module 130, the light-emitting module 130 may be easily coupled. Although the light-emitting module 130 receives a strong force from a lower direction, since the vertical fixing part 124b is Z-shaped, the light-emitting module 130 may not be detached from the vertical fixing part 124b.

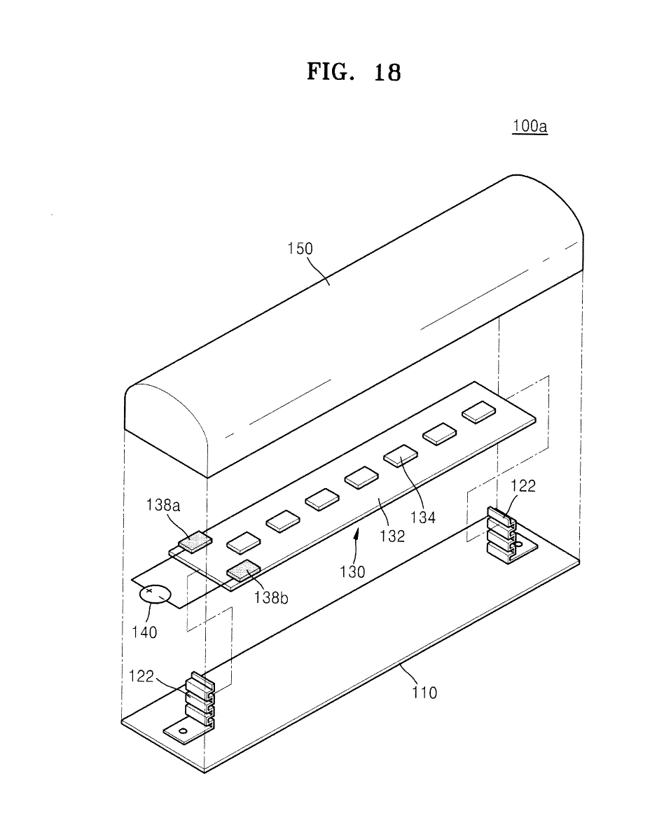

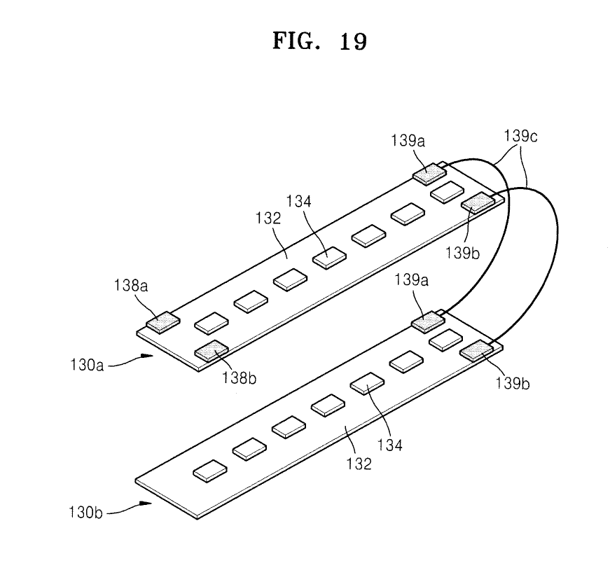

FIG. 18 is an exploded perspective view of a lighting apparatus 100a, according to another embodiment of the inventive concept.

Referring to FIG. 18, power connectors 138a and 138b that are electrically connectable to a lighting power source 140 are arranged on a surface of a light-emitting module 130. The power connectors 138a and 138b may be configured to be directly connected to a power cable. Selectively, the power connectors 138a and 138b may be configured to be coupled with female and/or male connectors arranged at the power cable.

In the embodiment of FIG. 18, power is supplied to the light-emitting module 130 via the power connectors 138a and 138b, and thus, multilevel fixing pin 122 may not be an electrical conductor.

In the embodiment of FIG. 18, the multilevel fixing pins 122 may support two facing sides of the light-emitting module 130. Referring to FIG. 18, two multilevel fixing pins 122 support one light-emitting module 130, but three or more multilevel fixing pins 122 may support one light-emitting module 130.

The lighting apparatus 100a of FIG. 18 may be easily converted from a conventional lighting apparatus, e.g., a lighting apparatus that employs a plug-in (PL) type lamp that does not use an LED. In particular, a plurality of coupling openings for various applications are formed in a body of a widely-used lighting apparatus that employs a PL type lamp. In this regard, a major process of a conversion procedure may be completed by installing a multilevel fixing pin at some of the coupling openings that are randomly selected.

The embodiment of FIG. 19 is different from the embodiment of FIG. 18 in that light-emitting modules 130a and 130b may be extended by using a jump cable 139c. Except for the fact that the light-emitting modules 130a and 130b may be extended, the embodiment of FIG. 19 is the same as the embodiment of FIG. 18, and thus, other elements are not illustrated.

Referring to FIG. 19, jumping connectors 139a and 139b are arranged on surfaces of the light-emitting modules 130a and 130b, and the light-emitting modules 130a and 130b may be electrically connected to each other via the jump cable 139c.

In the embodiment of FIG. 19, two light-emitting modules 130a and 130b are connected to each other, but it is obvious to one of ordinary skill in the art that a plurality of light-emitting modules may be connected in series and/or in parallel.

The light-emitting module 130a and 130b may be fixed respectively at multilevel fixing pins that are fixed on a surface of a lighting apparatus body.

As described above, by connecting at least two light-emitting modules 130a and 130b, it is possible to obtain the aforementioned effect in surface lighting.

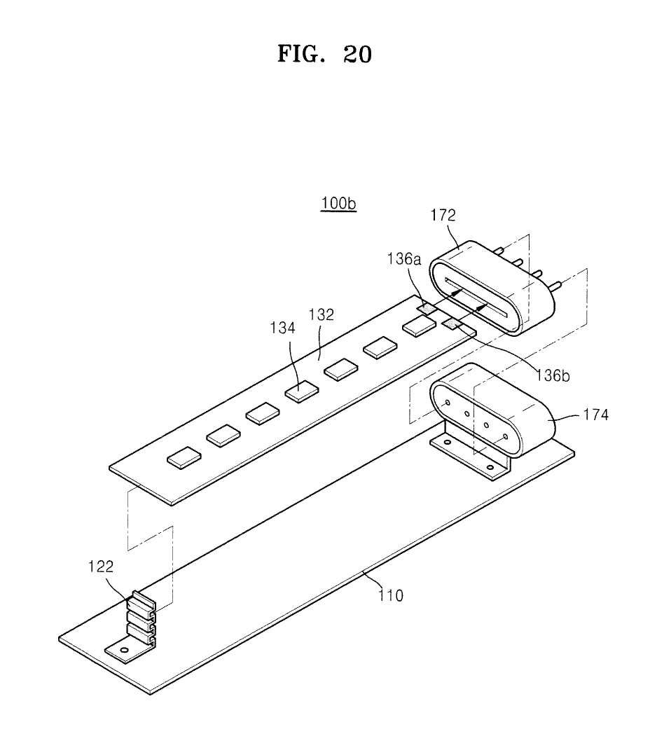

FIG. 20 is an exploded perspective view of a lighting apparatus 100b, according to another embodiment of the inventive concept.

Referring to FIG. 20, a lamp socket 174 may be further arranged on a lighting apparatus body 110. The lamp socket 174 may be coupled with a general PL lamp.

The lamp socket 174 may be electrically connected with a light-emitting module 130, and when the lamp socket 174 is enabled to be coupled with a general PL lamp, a socket adaptor 172 may be further provided to electrically connect them.

One side of the socket adaptor 172 may be coupled with the light-emitting module 130. As illustrated in FIG. 20, a recess part may be arranged in one side of the socket adaptor 172, and the light-emitting module 130 may be inserted into the recess part. Also, electrodes 136a and 136b may be arranged at an end of the light-emitting module 130 that is inserted into the recess part. The electrodes 136a and 136b may be electrically connected with terminals in the recess part of the socket adaptor 172.

Also, terminals to be coupled with the lamp socket 174 may be arranged at the other end of the socket adaptor 172. In the embodiment of FIG. 20, four terminals are respectively inserted into recess holes in a side surface of the lamp socket 174, so that the light-emitting module 130 and the lamp socket 174 may be electrically connected.

Referring to FIG. 20, another end of the light-emitting module 130 that is opposite to the end that is electrically connected with the socket adaptor 172 may be supported by a multilevel fixing pin 122. In the embodiment of FIG. 20, one multilevel fixing pin 122 is arranged to face the lamp socket 174, but one or more embodiments are not limited thereto.

For example, two edges of the light-emitting module 130 that are respectively adjacent to the end of the light-emitting module 130 may be fixed at two multilevel fixing pins 122 facing each other.

If the lamp socket 174 is for a conventional PL lamp, one or more multilevel fixing pins 122 can be additionally attached on a side of the lighting apparatus body 110 to support the light-emitting module 130, a conventional lighting apparatus may be easily converted into a lighting apparatus that uses an LED module.

In this case height adjustment may be only available at the end that is fixed at the multilevel fixing pin 122, and may not be available at the other end that is coupled with the lamp socket 174. However, due to a tolerance of the other end that is coupled with the lamp socket 174, the height adjustment at the end that is coupled with the multilevel fixing pin 122 may be possible to an extent.

In order to control LED lighting with a user-friendly function, it is necessary to develop a control technology according to an analysis with respect to psychological and biological influences on a person due to a white and/or mixed color LED light source, and also, it is possible to design an apparatus by analyzing an effect of the apparatus on a person due to spatial arrangement, array, and form.

In consideration of an influence on a human biorhythm, a psychological status, academic achievement, a work ability, or the like due to ambient illumination, it is possible to design a digital lighting control such as a wireless (remote) control or artificial intelligence sensing on color, temperature, brightness, or the like of illumination, by using a portable device such as a smartphone.

For example, for a math class, blue illumination having a color temperature CCT of about 7600 through about 8000 Kelvin (K) is highly effective, for a language class, general illumination having a CCT of about 4200 through about 4600K is highly effective, and for art and music classes, red illumination having a CCT of about 2200 through about 2600K is highly effective, and by providing optimized color illumination based on an influence of brightness and color temperature of illumination with respect to brain waves and psychological statuses, it is possible to provide a customized lighting apparatus so as to improve study and work efficiency.

Also, by adding a communication function to LED lighting apparatuses and display devices, it is possible to achieve a visible-light wireless communication technology to simultaneously use LED lighting apparatuses for both their intended purpose as an LED light source and an additional purpose as a communication means. This is because the LED light source is advantageous in that the LED light source has a long lifetime and excellent electric power efficiency, realizes various colors, has a fast switching speed for digital communication, and may be digitally controlled.

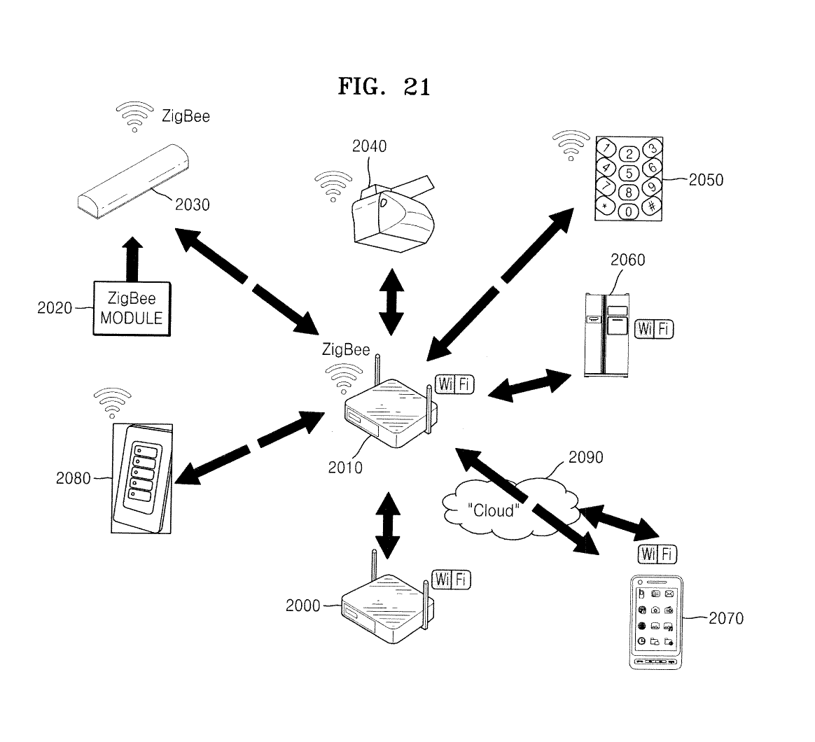

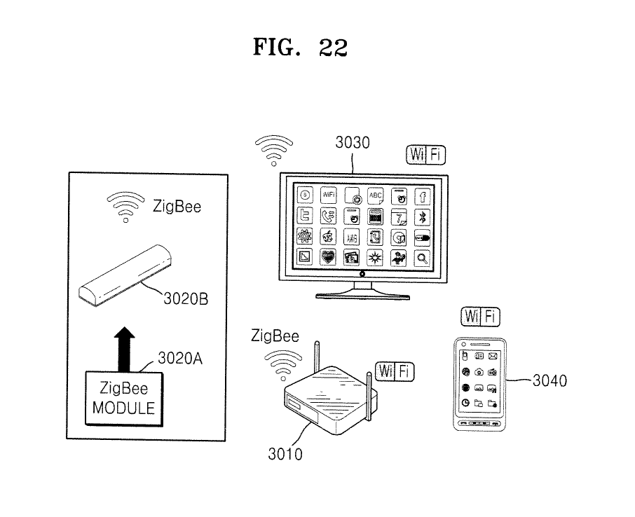

FIGS. 21 and 22 illustrate a home network to which a lighting system using a photo sensor integrated-type light-emitting apparatus is applied, according to an embodiment of the inventive concept.

As illustrated in FIG. 21, the home network may include a home wireless router 2000, a gateway hub 2010, a ZigBee module 2020, an LED lamp 2030, a garage door lock 2040, a wireless door lock 2050, home application 2060, a cell phone 2070, a wall-mounted switch 2080, and a cloud network 2090.

According to operating statuses of a bedroom, a living room, an entrance, a garage, electric home appliances, or the like and ambient environments/situations, illumination brightness of the LED lamp 2030 may be automatically adjusted by using in-house wireless communication such as ZigBee, Wi-Fi, or the like.

For example, as illustrated in FIG. 22, according to a type of a program broadcasted on a TV 3030 or brightness of a screen of the TV 3030, illumination brightness of an LED lamp 3020B may be automatically adjusted by using a gateway 3010 and a ZigBee module 3020A. In an embodiment, when a cozy atmosphere is required due to broadcasting of a soap opera, illumination may be adjusted to have a color temperature equal to or less than 12,000K according to the cozy atmosphere. In another embodiment, when a light atmosphere is required due to broadcasting of a comedy program, illumination may be adjusted to have a color temperature equal to or greater than 12,000K and may have a blue-based white color.

The ZigBee module 2020 or 3020A may be integrally modularized with a photo sensor, and may be integrally formed with a light-emitting apparatus.

The visible-light wireless communication technology involves wirelessly delivering information by using light having a visible wavelength band that is visible to human eyes. The visible-light wireless communication technology is different from a conventional wired optical communication technology and conventional infrared wireless communication in that the visible-light wireless communication technology uses light having a visible wavelength band, and is different from the conventional wired optical communication technology in that the visible-light wireless communication technology uses a wireless environment. Also, the visible-light wireless communication technology has excellent convenience and physical security in that the visible-light wireless communication technology is not regulated or controlled in terms of a frequency usage, unlike conventional radio frequency (RE) wireless communication, is unique since a user may check a communication link, and most of all, the visible-light wireless communication technology has a characteristic of a convergence technology by simultaneously allowing for an light source to be used for its original purpose and an additional purpose of a communication function.

Also, the LED illumination may be used as inner or outer light sources for vehicles. For the inner light sources, the LED illumination may be used as an inner light, a reading light, a gauge board, or the like for vehicles, and for the outer light sources, the LED illumination may be used as a headlight, a brake light, a direction guide light, a fog light, a daytime running light, or the like for vehicles.

An LED using a particular wavelength may promote a growth of plants, may stabilize human feelings, or may help treatment for a disease. The LED may be applied to a light source that is used in robots or various mechanical equipment. In addition to the LED having low power consumption and a long lifetime, it is possible to embody illumination of the present invention in combination with a nature-friendly renewable energy power system such as a solar cell system, a wind power system, or the like.

While the inventive concept has been particularly shown and described with reference to exemplary embodiments thereof, it will be understood that various changes in form and details may be made therein without departing from the spirit and scope of the following claims.

What is claimed is:

1. A lighting apparatus comprising:
a lighting apparatus body;
one or more multilevel fixing pins coupled to the lighting apparatus body; and
a light-emitting module fixed at the one or more multilevel fixing pins,
wherein the light-emitting module is configured to receive power from a lighting power supply device.

2. The lighting apparatus of claim 1, wherein the one or more multilevel fixing pins are formed to fix the light-emitting module at one of different levels.

3. The lighting apparatus of claim 2, wherein each of the one or more multilevel fixing pins has at least two grooves at the different levels at which the light-emitting module is to be fixed.

4. The lighting apparatus of claim 3, wherein a cross-section of each of the at least two grooves comprises at least one of a circular shape, a wedge shape, a Z-shape, or a quadrangular-shape.

5. The lighting apparatus of claim 3, wherein the one or more multilevel fixing pins are formed of an electroconductive material, and are connected to an electrode of the light-emitting module.

6. The lighting apparatus of claim 5, wherein the one or more multilevel fixing pins are electrically connected to the lighting power supply device.

7. The lighting apparatus of claim 1, further comprising a power connector that is arranged on the light-emitting module and is electrically connectable to the lighting power supply device.

8. The lighting apparatus of claim 7, further comprising a jumping connector that is arranged on the light-emitting module and is electrically connectable to another light-emitting module.

9. The lighting apparatus of claim 7, wherein the one or more multilevel fixing pins support two facing sides of the light-emitting module.

10. The lighting apparatus of claim 1, further comprising a lamp socket on the lighting apparatus body, and
wherein the light-emitting module is electrically connected to the lamp socket.

11. The lighting apparatus of claim 10, further comprising a socket adaptor that electrically connects the light-emitting module and the lamp socket,
wherein one side of the socket adaptor is couplable with the light-emitting module, and
the other side of the socket adaptor is couplable with the lamp socket.

12. The lighting apparatus of claim 1, further comprising a compressible resilient body between the lighting apparatus body and the light-emitting module.

13. A multilevel fixing pin for fixing a light-emitting module in a lighting apparatus, the multilevel fixing pin comprising:
a horizontal fixing part configured to be coupled with a lighting apparatus body; and
a vertical fixing part comprising at least two grooves to fix a light-emitting module,
wherein a cross-section of each of the at least two grooves comprises at least one of a circular shape, a wedge shape, a Z-shape, or a quadrangular-shape.

14. The multilevel fixing pin of claim 13, wherein the multilevel fixing pin is formed of an electroconductive material.

15. The multilevel fixing pin of claim 13, further comprising a coupling opening that is arranged at the horizontal fixing part.

16. A lighting apparatus comprising:
a lighting apparatus body;
one or more multilevel fixing pins coupled to the lighting apparatus body, each of the multilevel fixing pins including a horizontal fixing part and a vertical fixing part; and
a light-emitting module fixed at the one or more multilevel fixing pins,
wherein the vertical fixing part includes at least two grooves and the light-emitting module is inserted into one of the at least two grooves.

17. The lighting apparatus of claim 16, wherein the one or more multilevel fixing pins are disposed on the lighting apparatus body to support the light-emitting module.

18. The lighting apparatus of claim 16, the vertical fixing part is deformable in response to a force applied thereto in a horizontal direction and is restorable by removing the force.

19. The lighting apparatus of claim 16, the horizontal fixing part has a coupling opening for detachable coupling with the lighting apparatus body.

20. The lighting apparatus of claim 16, further comprising diffusion plate to cover the light-emitting module.
